(19) United States
(12) Patent Application Publication
(10) Pub. No.: US 2021/0382856 A1
(43) Pub. Date: Dec. 9, 2021

(54) CLOUD DATA SHARING METHOD SUPPORTING NATIVE APPLICATIONS AND CONTAINERIZED APPLICATIONS AND STORAGE DEVICE USING SAME

(71) Applicant: QNAP SYSTEMS, INC., NEW TAIPEI CITY (TW)

(72) Inventor: Shih-Chieh HSU, NEW TAIPEI CITY (TW)

(21) Appl. No.: 16/920,542

(22) Filed: Jul. 3, 2020

(30) Foreign Application Priority Data
Jun. 4, 2020 (TW) 109118854

(51) Int. Cl. G06F 16/188; G06F 16/18; G06F 16/17; G06F 9/54; G06F 9/455

(52) U.S. Cl. CPC G06F 16/188; G06F 16/1847; G06F 9/455; G06F 9/542; G06F 16/1734

(57) ABSTRACT

A cloud data sharing method supporting native applications and containerized applications, including: using a user-space file system to mount at least one cloud storage server to a virtual file system; using a cloud agent module to register a push notification service with a cloud storage service module of each cloud storage server, so that when the content of a file stored in one cloud storage server is altered, the cloud agent module can receive a content-altered notification of the file and send the content-altered notification to a message broker module; and using the message broker module to accept a file-altered-notification subscription from at least one native application or at least one containerized application, so that when the message broker module receives the file-altered notification from the cloud agent module, the message broker module can publish a file-altered message to one native application or one containerized application.

### BACKGROUND OF THE INVENTION

### Field of the Invention

The present invention relates to a cloud data sharing method, in particular to a cloud data sharing method supporting native applications and containerized applications.

### Description of the Related Art

As network technologies become more and more developed, cloud storage services are also more convenient, fast, and diverse. Today's users can access data through browsers or client applications provided by various cloud service providers, and general cloud service providers also provide various application programming interfaces (APIs) so that users can develop their own client applications to meet various data access requirements. It is known that an individual client application has been developed by integrating these application programming interfaces to define a user-space file system and a virtual file system that interacts with the user-space file system, so that various applications can view the virtual file system as a general file system, and can access a cloud storage device through the virtual file system and the user-space file system.

However, when the data stored in the cloud storage device is changed through other channels, the individual client application cannot be immediately informed, resulting in the data changes cannot be updated simultaneously in a local storage device with the virtual file system. This is a shortcoming of the aforementioned individual client application.

Therefore, there is an urgent need for a novel cloud data sharing technical solution in the field.

### SUMMARY OF THE INVENTION

One objective of the present invention is to provide a cloud data sharing method, which can support both native applications and containerized applications.

Another objective of the present invention is to provide a cloud data sharing method, which can enable a client application to be instantly informed of the content changes of a cloud file through a push notification service provided by a cloud storage service module.

Still another objective of the present invention is to provide a cloud data sharing method, which can enable the storage content of a local SSD device to be updated in real time as the content of a cloud storage device changes.

To achieve the aforementioned objectives, a cloud data sharing method supporting native applications and containerized applications is proposed, which is implemented by a data storage device, and the method includes:

using a user-space file system to mount at least one cloud storage server to a virtual file system;

using a cloud agent module to register a push notification service with a cloud storage service module of each of the at least one cloud storage server, so that when a content of a file stored in one of the at least one cloud storage server changes, the cloud agent module can receive a content-altered notification of the file and send the content-altered notification to a message broker module; and

using the message broker module to accept a file-altered-notification subscription from at least one native application or at least one containerized application, so that when the message broker module receives the content-altered notification from the cloud agent module, the message broker module can publish a file-altered message to one of the at least one native application or one of the at least one containerized application.

In one embodiment, one of the at least one native application or one of the at least one containerized application will respond to the file-altered message to read a corresponding file in one of the at least one cloud storage server through the virtual file system, and perform an image processing procedure on the corresponding file to generate a processed file, and then store the processed file in an SSD device in the data storage device through the virtual file system.

In one embodiment, the data storage device has a LINUX operating system, and the user-space file system, the virtual file system, the cloud agent module, the message broker module, the native application and the containerized application are all mounted on the Linux operating system.

In one embodiment, the message broker module is a functional module that supports containerized inter-process communication (IPC).

In one embodiment, the data storage device communicates with at least one user native application or at least one user containerized application via a network, so that the at least one user native application and the at least one user containerized application program can communicate respectively with the at least one native application and the at least one containerized application in the data storage device.

To achieve the above objectives, the present invention further provides a storage device, which has an SSD device and an information processing device to implement a cloud data sharing method that supports native applications and containerized applications, the method includes:

using a user-space file system to mount at least one cloud storage server to a virtual file system;

using a cloud agent module to register a push notification service with a cloud storage service module of each of the at least one cloud storage server, so that when a content of a file stored in one of the at least one cloud storage server changes, the cloud agent module can receive a content-altered notification of the file and send the content-altered notification to a message broker module; and

using the message broker module to accept a file-altered-notification subscription from at least one native application or at least one containerized application, so that when the message broker module receives the content-altered notification from the cloud agent module, the message broker module can publish a file-altered message to one of the at least one native application or one of the at least one containerized application.

In one embodiment, one of the at least one native application or one of the at least one containerized application will respond to the file-altered message to read a corresponding file in one of the at least one cloud storage server through the virtual file system, and perform an image processing procedure on the corresponding file to generate a processed file, and then store the processed file in an SSD device in the data storage device through the virtual file system.

In one embodiment, the data storage device has a LINUX operating system, and the user-space file system, the virtual file system, the cloud agent module, the message broker module, the native application and the containerized application are all mounted on the Linux operating system.

In one embodiment, the message broker module is a functional module that supports containerized inter-process communication (IPC).

In one embodiment, the data storage device communicates with at least one user native application or at least one user containerized application via a network, so that the at least one user native application and the at least one user containerized application program can communicate respectively with the at least one native application and the at least one containerized application in the data storage device.

### BRIEF DESCRIPTION OF THE DRAWINGS

FIG. 1 illustrates a flowchart of a cloud data sharing method supporting native applications and containerized applications according to one embodiment of the present invention.

FIG. 2 illustrates a block diagram of a storage device according to one embodiment of the present invention.

FIG. 3 illustrates a block diagram of a hardware architecture of the information processing device of the storage device of FIG. 2 according to one embodiment of the present invention.

FIG. 4 illustrates a schematic diagram of a message transmission process in the information processing device of the storage device of FIG. 2.

### DETAILED DESCRIPTION OF THE PREFERRED EMBODIMENTS

To make it easier for our examiner to understand the objective of the invention, its structure, innovative features, and performance, we use preferred embodiments together with the accompanying drawings for the detailed description of the invention.

The principle of the present invention lies in:

(1) installing a cloud agent module in a data storage device to register a push notification service with each cloud storage server, so as to instantly learn the content-altered information of at least one file in each cloud storage server;

(2) installing a message broker module in the data storage device to receive the content-altered message of the at least one file provided by the cloud agent module; and

(3) installing at least one native application and at least one containerized application in the data storage device, where when a native application or a containerized application receives the content-altered message provided by the message broker module, the native application or the containerized application can read the at least one file through a network, and perform an image processing procedure on the at least one file to generate at least one processed file, and then store the at least one processed file in an SSD device in the data storage device.

According to the above design, a user native application (or a user containerized application) can communicate with one native application (or one containerized application) in the data storage device via the network to obtain the latest content of a target file from the SSD device of the data storage device, that is, as a native application (or a containerized application) in the data storage device will ensure the content changes of the target file stored in the SSD device be synchronized with the content changes of a corresponding file in a cloud storage server, therefore, when a user native application (or a user containerized application) requests the target file, a native application (or a containerized application) in the data storage device only has to read the target file in the SSD device without the need of requesting the corresponding file from the cloud storage server to quickly provide the latest content of the target file to the user native application (or the user containerized application).

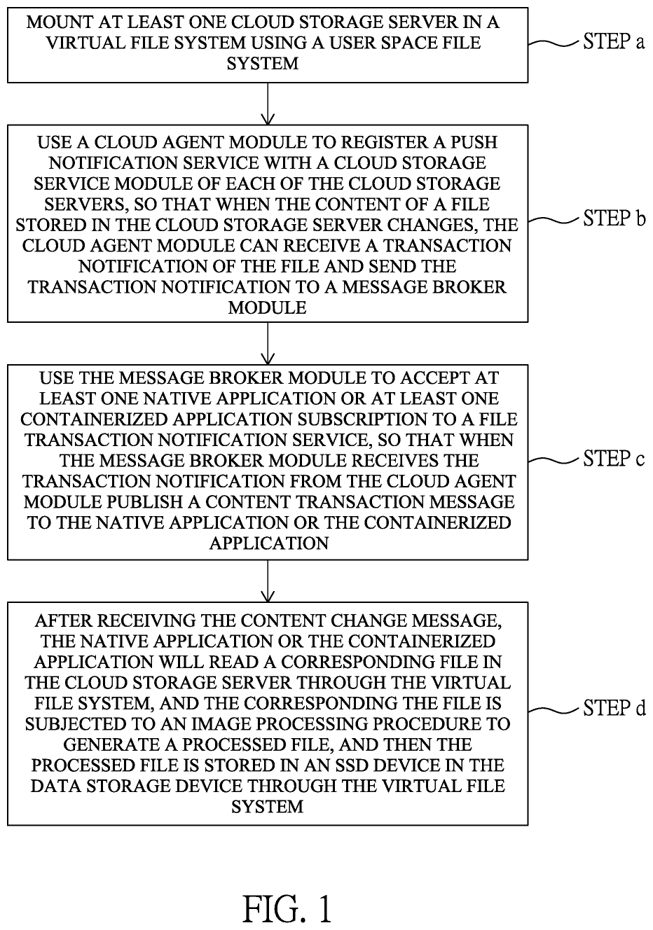

Please refer to FIG. 1, which illustrates a flowchart of a cloud data sharing method supporting native applications and containerized applications according to one embodiment of the present invention, the method being implemented by a data storage device. As shown in FIG. 1, the method includes: using a user-space file system to mount at least one cloud storage server to a virtual file system (step a); using a cloud agent module to register a push notification service with a cloud storage service module of each of the at least one cloud storage server, so that when a content of a file stored in one of the at least one cloud storage server changes, the cloud agent module can receive a content-altered notification of the file and send the content-altered notification to a message broker module (step b); using the message broker module to accept a file-altered-notification subscription from at least one native application or at least one containerized application, so that when the message broker module receives the content-altered notification from the cloud agent module, the message broker module can publish a file-altered message to one of the at least one native application or one of the at least one containerized application (step c); and one of the at least one native application or one of the at least one containerized application will respond to the file-altered message to read a corresponding file in one of the at least one cloud storage server through the virtual file system, and perform an image processing procedure on the corresponding file to generate a processed file, and then store the processed file in an SSD device in the data storage device through the virtual file system (step d).

Preferably, the data storage device may have a LINUX operating system, and the user-space file system, the virtual file system, the cloud agent module, the message broker module, the native application and the containerized application are all mounted on the Linux operating system.

In addition, in step c, the native application refers to an application program using a language supported by the operating system of the data storage device, and the containerized application refers to an application program that interacts with the operating system via a container.

In addition, the message broker module is a functional module that supports containerized inter-process communication (IPC).

In addition, the data storage device communicates with at least one user native application or at least one user containerized application via a network, so that the at least one user native application and the at least one user containerized application program can communicate respectively with the at least one native application and the at least one containerized application in the data storage device.

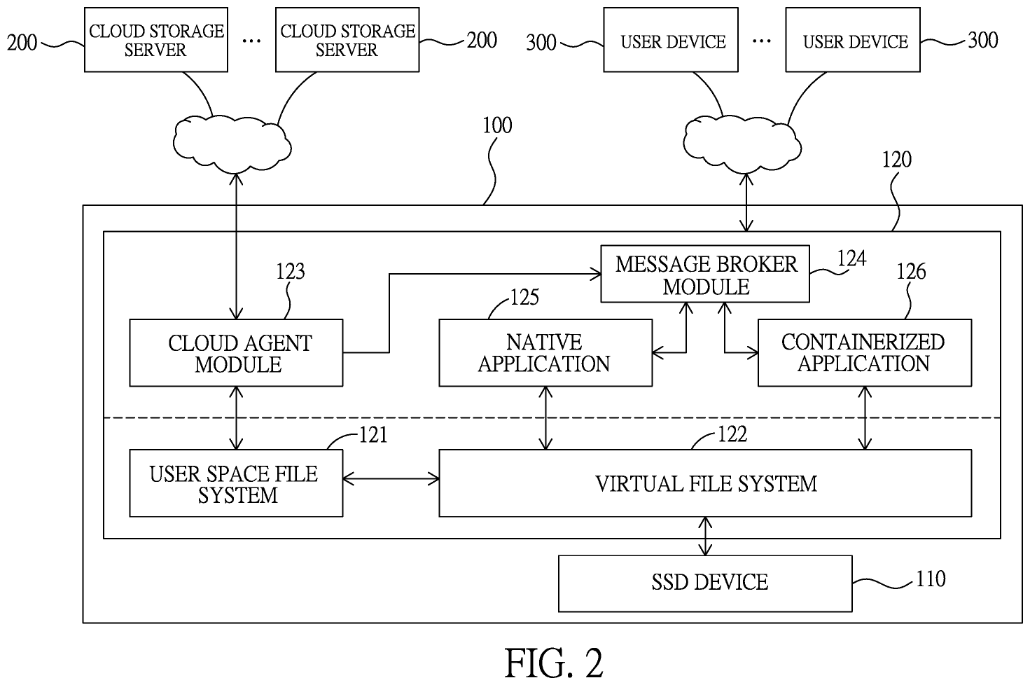

Based on the above description, the present invention further provides a storage device. Please refer to FIG. 2, which illustrates a block diagram of a storage device according to one embodiment of the present invention. As shown in FIG. 2, a storage device 100 has an SSD (solid state disk) device 110 and an information processing device 120 to implement a cloud data sharing method supporting native applications and containerized applications. The information processing device 120 has an operating system, such as (but not limited to) a Linux operating system, and the information processing device 120 has a user-space file system 121, a virtual file system 122, a cloud agent module 123, a message broker module 124, at least one native application 125 and at least one containerized application 126, where the user-space file system 121 and the virtual file system 122 are mounted in the core layer of the operating system, and the cloud agent module 123, the message broker module 124, the at least one native application 125 and the at least one containerized application 126 are mounted in the application layer of the operating system. The method includes:

(1) using the user-space file system 121 to mount at least one cloud storage server 200 to the virtual file system 122;

(2) using the cloud agent module 123 to register a push notification service with a cloud storage server module of each cloud storage server 200, so that when the content of a file stored in one cloud storage server 200 is altered, the cloud agent module 123 can receive a content-altered notification of the file and send the content-altered notification to the message broker module 124;

(3) using the message broker module 124 to accept a file-altered-notification subscription from at least one native application 125 or at least one containerized application 126, so that when the message broker module 124 receives the content-altered notification from the cloud agent module 123, the message broker module 124 can publish a file-altered message to one native application 125 or one containerized application 126; and

(4) one native application 125 or one containerized application 126 will respond to the file-altered message to read a corresponding file in one cloud storage server 200 through the virtual file system, and perform an image processing procedure on the corresponding file to generate a processed file, and then store the processed file in the SSD device 110 via the virtual file system 122.

In addition, the message broker module 124 is a functional module that supports containerized inter-process communication (IPC).

In addition, the information processing device 120 communicates with a user native application or a user containerized application of at least one user device 300 via a network, so that the at least one user native application and the at least one user containerized application can interact respectively with the at least one native application 125 and the at least one containerized application 126 in the information processing device 120, where the user device 300 may be a personal computer, a portable computer, or smart phone.

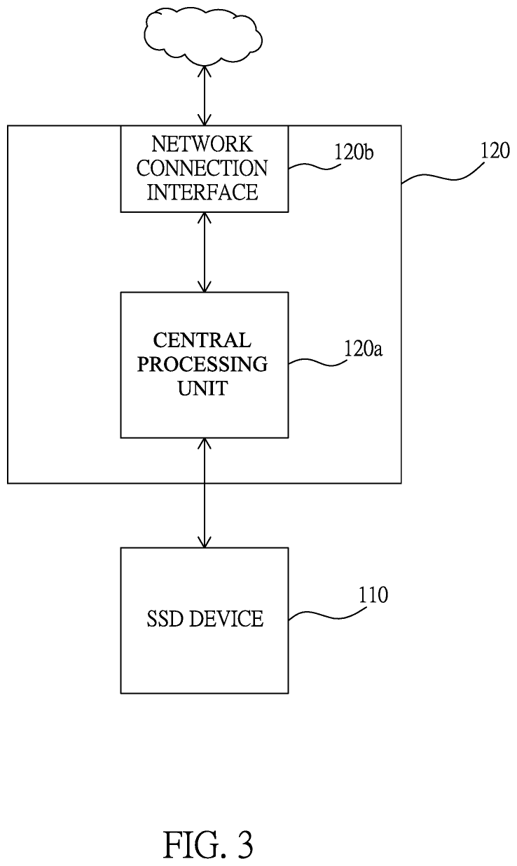

Please refer to FIG. 3, which illustrates a block diagram of a hardware architecture of the information processing device of the storage device of FIG. 2 according to one embodiment of the present invention. As shown in FIG. 3, the information processing device 120 has a central processing unit 120a and a network connection interface 120b, where the central processing unit 120a is used to execute the operating system, the user space file system 121, the virtual file system 122, the cloud agent module 123, the message broker module 124, at least one native application 125 and at least one containerized application 126; the network connection interface 120b is used to communicate with the user native application or the user containerized application of at least one user device 300 via a network.

When in operation, through the message transfer between the cloud agent module 123 and the message broker module 124, the native application 125 and the containerized application 126 can instantly learn the content-altered information of a file stored in a cloud storage server 200, and in response read the file via the virtual file system 122, and perform an image processing procedure on the file to generate a processed file, and then store the processed file in the SSD device 110 via the virtual file system 122.

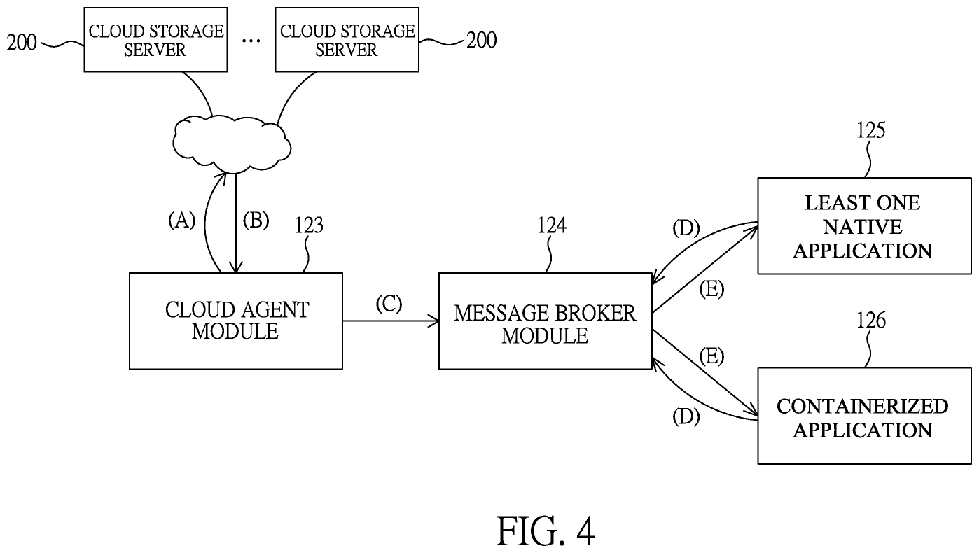

Please refer to FIG. 4, which illustrates a schematic diagram of a message transmission process in the information processing device of the storage device of FIG. 2. As shown in FIG. 4, the message transfer process includes: (A) the cloud agent module 123 registers a push notification service with a cloud storage service module of a cloud storage server 200; (B) the cloud storage service module issues a content-altered notification to the cloud agent module 123 when the content of a file stored in the cloud storage server 200 is altered; (C) the cloud agent module 123 sends the content-altered notification to the message broker module 124; (D) a native application 125 or a containerized application 126 subscribes to the message broker module 124 for a file-altered-notification service; and (E) the message broker module 124 publishes a file-altered notification to the native application 125 or the containerized application 126 when receiving the content-altered notification from the cloud agent module 123.

It can be seen from the above description that the present invention has the following advantages:

(1) The cloud data sharing method of the present invention can support both native applications and containerized applications.

(2) The cloud data sharing method of the present invention can enable the applications on the user side to instantly learn the content changes of a cloud file by using a push notification service provided by a cloud storage service module.

(3) The cloud data sharing method of the present invention can enable the storage content of a local SSD device to be updated in real time as the content of a cloud storage device changes, so that when a user native application (or a user containerized application) requests the target file, a native application (or a containerized application) in the data storage device only has to read the target file in the SSD device without the need of requesting the corresponding file from the cloud storage server to quickly provide the latest content of the target file to the user native application (or the user containerized application).

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A cloud data sharing method supporting native applications and containerized applications, which is implemented by a data storage device, including:
using a user-space file system to mount at least one cloud storage server to a virtual file system;
using a cloud agent module to register a push notification service with a cloud storage service module of each said cloud storage server, so that when a content of a file stored in one said cloud storage server changes, the cloud agent module can receive a content-altered notification of the file and send the content-altered notification to a message broker module; and
using the message broker module to accept a file-altered-notification subscription from at least one native application or at least one containerized application, so that when the message broker module receives the content-altered notification from the cloud agent module, the message broker module can publish a file-altered message to one said native application or one said containerized application.

2. The cloud data sharing method supporting native applications and containerized applications as disclosed in claim 1, wherein one said native application or one said containerized application will respond to the file-altered message to read a corresponding file in one said cloud storage server through the virtual file system, and perform an image processing procedure on the corresponding file to generate a processed file, and then store the processed file in an SSD device in the data storage device through the virtual file system.

3. The cloud data sharing method supporting native applications and containerized applications as disclosed in claim 1, wherein the data storage device has a LINUX operating system, and the user-space file system, the virtual file system, the cloud agent module, the message broker module, the native application and the containerized application are all mounted on the Linux operating system.

4. The cloud data sharing method supporting native applications and containerized applications as disclosed in claim 1, wherein the message broker module is a functional module that supports containerized inter-process communication.

5. The cloud data sharing method supporting native applications and containerized applications as disclosed in claim 1, wherein the data storage device communicates with at least one user native application or at least one user containerized application via a network, so that the at least one user native application and the at least one user containerized application program can communicate respectively with the at least one native application and the at least one containerized application in the data storage device.

6. A storage device having an SSD device and an information processing device to implement a cloud data sharing method supporting native applications and containerized applications, the method including:
using a user-space file system to mount at least one cloud storage server to a virtual file system;
using a cloud agent module to register a push notification service with a cloud storage service module of each said cloud storage server, so that when a content of a file stored in one said cloud storage server changes, the cloud agent module can receive a content-altered notification of the file and send the content-altered notification to a message broker module; and
using the message broker module to accept a file-altered-notification subscription from at least one native application or at least one containerized application, so that when the message broker module receives the content-altered notification from the cloud agent module, the message broker module can publish a file-altered message to one said native application or one said containerized application.

7. The storage device as disclosed in claim 6, wherein one said native application or one said containerized application will respond to the file-altered message to read a corresponding file in one said cloud storage server through the virtual file system, and perform an image processing procedure on the corresponding file to generate a processed file, and then store the processed file in an SSD device in the data storage device through the virtual file system.

8. The storage device as disclosed in claim 6, wherein the data storage device has a LINUX operating system, and the user-space file system, the virtual file system, the cloud agent module, the message broker module, the native application and the containerized application are all mounted on the Linux operating system.

9. The storage device as disclosed in claim 6, wherein the message broker module is a functional module that supports containerized inter-process communication.

10. The storage device as disclosed in claim 6, wherein the data storage device communicates with at least one user native application or at least one user containerized application via a network, so that the at least one user native application and the at least one user containerized application program can communicate respectively with the at least one native application and the at least one containerized application in the data storage device.
